(19) United States
(12) Patent Application Publication
(10) Pub. No.: US 2008/0302797 A1
(43) Pub. Date: Dec. 11, 2008

(54) CONTAINER

(76) Inventor: EVAN IRA PHILLIPS, Coral Springs, FL (US)

Correspondence Address: LOWRIE, LANDO & ANASTASI, LLP, ONE MAIN STREET, SUITE 1100, CAMBRIDGE, MA, 02142, US

(21) Appl. No.: 11/761,133

(22) Filed: Jun. 11, 2007

(51) Int. Cl. B65D 41/32; B23P 19/04

(52) U.S. Cl. 220/266; 29/801

(57) ABSTRACT

Containers and methods of making them are disclosed. The containers comprise a closure system comprising a fixed element and a removable closure element. The containers may be constructed to improve sanitary conditions of the dispensing portion and allow for easier opening with the ability to be reclosed, over a conventional container.

### BACKGROUND OF THE INVENTION

1. Field of the Technology

At least one example of the present invention relates generally to a container. More particularly, certain examples relate to a container having a sanitary, enclosed dispensing portion, such that the dispensing portion remains protected from the environment during, for example, shipping and storage of the container, and may be protected from the environment during use by the consumer.

2. Discussion of Related Art

Beverages and foods come in a variety of containers for distribution and sale to consumers. In particular, conventional beverage cans having a stay-on-tab type closure are widely used because of their ease of manufacture, low manufacturing costs, and reliability. However, sanitary concerns exist with regard to the unprotected outside portion of the can that comes into contact with the contents while pouring from the beverage can, or comes directly into contact with the consumers while drinking from the beverage can. Additionally, some consumers have difficulty opening beverage cans, and once this beverage can has been opened, it cannot be reclosed, so that protection of the unprotected outside portion and storage after opening are not feasible.

### BRIEF SUMMARY OF THE INVENTION

Certain aspects and examples disclosed herein provide sanitary containers, and methods of making them.

In accordance with a first aspect, a container is provided comprising a container body, and a closure system. The closure system comprises a removable closure element and a fixed element secured to the container body. The fixed element comprises a dispensing portion comprising a spout constructed and arranged to be mated with the removable closure element, and a rim constructed and arranged to secure the dispensing portion to the container body.

In accordance with an additional aspect, a container is provided comprising a container body, a closure system, and a base plate. The closure system comprises a removable closure element and a fixed element secured to the container body. The fixed element comprises a dispensing portion comprising a spout constructed and arranged to be mated with the removable closure element, and a sealing portion constructed and arranged to secure the dispensing portion to the container body. The base plate is constructed and arranged to be attached to the container body opposite the closure system.

In accordance with another aspect, a method of making a container is provided, comprising providing a container body, disposing a closure system comprising a removable closure element and a fixed element comprising a dispensing portion and a rim to a first end of the container body having a first end, and securing the rim to the first edge of the container body.

In accordance with another aspect, a method of making a container is provided comprising providing a container body comprising a first opening and a second opening opposite the first opening, securing a closure system comprising a removable closure element and a fixed element to the first opening, and attaching a base plate to the second opening of the container body.

Other advantages, novel features and objects of the invention will become apparent from the following detailed description of the invention when considered in conjunction with the accompanying drawings.

### BRIEF DESCRIPTION OF THE DRAWINGS

Certain illustrative examples are described below with reference to the accompanying figures in which:

FIG. 1 illustrates an example of a side view of a beverage container, in accordance with certain examples;

FIG. 2 illustrates a cross-sectional view along section line 2-2 of the beverage container in FIG. 1, in accordance with certain examples;

FIG. 3 illustrates an exploded view of the beverage container shown in FIG. 1, in accordance with certain examples;

FIG. 4 illustrates a cross-sectional view along section line 4-4 of the beverage container shown in FIG. 3, in accordance with certain examples;

FIG. 5 illustrates a perspective exploded view of the beverage container shown in FIG. 1, in accordance with certain examples;

FIG. 6 illustrates a perspective view of a fixed element of a beverage container prior to attaching to a container body, in accordance with certain examples;

FIG. 7 illustrates a cross-sectional view of the fixed element of FIG. 6 showing a detail of the fixed element prior to attaching to a container body, in accordance with certain examples;

FIG. 8 illustrates a cross-sectional view of the beverage container of FIG. 1 showing a detail of the beverage container after attaching the fixed element to the container body of FIG. 1, in accordance with certain examples;

FIG. 9 illustrates an example of a side view of a beverage container, in accordance with certain examples;

FIG. 10 illustrates a cross-sectional view along section line 10-10 of the beverage container shown in FIG. 9, in accordance with certain examples;

FIG. 11 illustrates an exploded view of the beverage container shown in FIG. 9, in accordance with certain examples;

FIG. 12 illustrates a cross-sectional view along section line 12-12 of the beverage container in FIG. 1, in accordance with certain examples;

FIG. 13 illustrates a side internal and external view of a reclosable closure element, in accordance with certain examples;

FIG. 14 illustrates a perspective view of the reclosable closure element shown in FIG. 13, in accordance with certain examples;

FIG. 15 illustrates a perspective view of the reclosable closure element shown in FIG. 13, in accordance with certain examples;

FIG. 16 illustrates a side view of a beverage container, in accordance with certain examples;

FIG. 17 illustrates a cross-sectional view along section line 17-17 of the beverage container shown in FIG. 16, in accordance with certain examples;

FIG. 18 illustrates an exploded view of the beverage container shown in FIG. 16, in accordance with certain examples;

FIG. 19 illustrates a cross-sectional view along section line 19-19 of the beverage container in FIG. 18, in accordance with certain examples;

FIG. 19A illustrates a cross-sectional view of a beverage container showing a detail of the beverage container of FIG. 17, in accordance with certain examples;

FIG. 20 illustrates a side view of a beverage container, in accordance with certain examples;

FIG. 21 illustrates a cross-sectional view along section line 21-21 of the beverage container shown in FIG. 20, in accordance with certain examples;

FIG. 22 illustrates an exploded view of the beverage container shown in FIG. 20, in accordance with certain examples;

FIG. 23 illustrates a cross-sectional view along section line 23-23 of the beverage container shown in FIG. 22, in accordance with certain examples;

FIG. 24 illustrates an exploded view of the beverage container shown in FIG. 20, in accordance with certain examples;

FIG. 25 illustrates a cross-sectional view along section line 25-25 of the beverage container shown in FIG. 24, in accordance with certain examples;

FIG. 26 illustrates an exploded view of the beverage container shown in FIG. 20, in accordance with certain examples;

FIG. 27 illustrates a cross-sectional view along section line 27-27 of the beverage container shown in FIG. 26, in accordance with certain examples;

FIG. 28 illustrates a cross-sectional view of a beverage container showing a detail of the beverage container of FIG. 27, in accordance with certain examples;

FIG. 29 illustrates a side view of a beverage container, in accordance with certain examples;

FIG. 30 illustrates a cross-sectional view along section line 30-30 of the beverage container shown in FIG. 29, in accordance with certain examples;

FIG. 31 illustrates an exploded view of the beverage container shown in FIG. 29, in accordance with certain examples;

FIG. 32 illustrates a cross-sectional view along section line 32-32 of the beverage container shown in FIG. 31, in accordance with certain examples;

FIG. 33 illustrates a perspective exploded view of the beverage container shown in FIG. 29, in accordance with certain examples;

FIG. 34 illustrates a cross-sectional view of the beverage container showing a detail of the beverage container of FIG. 30, in accordance with certain examples;

FIG. 35 illustrates a side view of a beverage container, in accordance with certain examples;

FIG. 36 illustrates a cross-sectional view along section line 36-36 of the beverage container in FIG. 35, in accordance with certain examples;

FIG. 37 illustrates an exploded view of a beverage container, in accordance with certain examples;

FIG. 38 illustrates a cross-sectional view along section line 38-38 of the beverage container in FIG. 37, in accordance with certain examples;

FIG. 39 illustrates a side view of a container body, in accordance with certain examples;

FIG. 40 illustrates a perspective view of a container body, in accordance with certain examples;

FIG. 41 illustrates a side view of two beverage containers, one stacked on top of another, in accordance with certain examples; and

FIG. 42 illustrates a cross-sectional view along section line 42-42 of the beverage containers shown in FIG. 41, in accordance with certain examples.

FIG. 43 illustrates a side view of a container, in accordance with certain examples;

FIG. 44 illustrates a cross-sectional view along section 44-44 of the container in FIG. 43, in accordance with certain examples;

FIG. 45 illustrates a perspective exploded view of the container of FIG. 43, in accordance with certain examples;

FIG. 46 illustrates a perspective exploded view of the container of FIG. 43, in accordance with certain examples;

FIG. 47 illustrates a perspective exploded view of the container of FIG. 43, in accordance with certain examples;

FIG. 48 illustrates a perspective partially exploded view of the container of FIG. 43, in accordance with certain examples.

FIG. 49 illustrates a cross-sectional view showing a detail of the container of FIG. 44, in accordance with certain examples.

FIG. 50 illustrates a perspective partially exploded view of the container of FIG. 43, in accordance with certain examples.

FIG. 51 illustrates a perspective view of the container of FIG. 43, in accordance with certain examples.

Certain features or components of the illustrative containers shown in the figures may have been enlarged, distorted or otherwise shown in a non-conventional manner relative to other features or components to facilitate a better understanding of the novel devices and methods disclosed herein. It will be recognized by the person of ordinary skill in the art, given the benefit of this disclosure, that the containers disclosed herein, and methods of making them, can be used in any orientation relative to gravity and suitable orientations will be readily selected by the person of ordinary skill in the art, given the benefit of this disclosure.

### DETAILED DESCRIPTION OF THE INVENTION

Certain examples of the devices and methods disclosed herein will be recognized by the person of ordinary skill in the art, given the benefit of this disclosure to provide sanitary, cost-effective containers. In particular, beverage containers are provided that have a sanitary cover, are easier to open than conventional cans, and can be resealed an unlimited number of times. The beverage container of certain examples disclosed herein will prevent the dispensing portion of the beverage container from exposure to the environment and ensure a safe and contaminant-free product. The current manufacturing process for beverage cans may be adapted to include the present invention, with reduced, minimal or no additional cost.

Conventional beverage containers, such as aluminum cans, are manufactured by well-known processes. In one process, aluminum cans are made from an aluminum coiled sheet which is fed through a cupping press that cuts discs and forms them into cup-like containers. These cups drop from the press onto a conveyor, and are fed into an ironing press where successive rings redraw and iron the cup, reducing the sidewall thickness, and achieving a full length can. The tops of the can bodies are then trimmed to eliminate rough edges and ensure height uniformity. The can bodies are then cleaned and dried. Subsequently, the can bodies are labeled and coated with a clear protective layer of varnish. The cans are then baked, treated with a coating, and re-baked. The top portion of each can body is narrowed to form a neck with an outward flange at the top edge. The bottom portions are domed to obtain the strength required to withstand internal pressure if a carbonated liquid will be added to the can. After testing for pin-holes and defects, the can bodies are placed on pallets and shipped to a beverage supplier.

The lids of conventional aluminum cans, typically referred to as “can ends,” are made by stamping shells from an aluminum coiled sheet. The shells are coated with a sealant, and subsequently a rivet is placed in each can end. On those cans using a stay-on-tab type closure, the process further includes inserting a separate piece of metal as the tab under the rivet to secure it in place. The edges of the can ends generally have a curved flange. The can ends are also scored to define the opening of the can end in the finished product. The can ends are then shipped to the beverage supplier, along with the can bodies.

At the beverage supplier, a filling machine is used to pour the beverage into the can body. The process is completed after filling when the can end is added, and secured to the can body by forming a double seam with the can body. A double seam is formed by interlocking edges of the two components, the outward top edge of the can body and the curved flange at the edge of the can end, curling the can end flange around the can body edge so that the can end flange is partially rolled up and under the can body edge to form a partial seam, and crimping and flattening the partial seam against the can body to form a hermetic seal.

Most beverage cans have a stay-on-tab type closure such as those disclosed in U.S. Pat. Nos. 3,967,752 and 3,967,753 to Cudzik, and described above. However, there are many aspects of the conventional stay-on-tab closure that make it undesirable. The stay-on-tab closure does not provide for a sanitary drinking environment because the outer surface of the can and the top of the can, which comprises the stay-on-tab closure, comes into contact with the environment during storage, shipping, distribution, display, handling, and ultimately, use by the consumer. When the beverage is poured directly from the can through the opening formed from the stay-on-tab closure, the beverage comes in contact with the top and surface of the can, making for a potentially unsanitary drinking environment. Additionally, if a consumer drinks the beverage from the can directly, both the beverage and the mouth of the consumer come into contact with the surface and top of the can, also making for an unsanitary drinking environment. Additionally, the stay-on-tab type closure does not allow for reclosing the beverage container.

The present invention provides a beverage container that may be manufactured by commercially available processes and machinery with minimal retrofitting, low material and manufacturing costs, ease of stacking during shipping and storage, increased sanitary conditions of the dispensing portion, reliability and ease of opening and closing by consumers, pourability, drinkability, recyclability, and decreased likelihood of spilling the contents of the container. These advantages of the present invention overcome the noted deficiencies of the conventional stay-on-tab type closure beverage containers.

As used herein, the term “mate” or “mating” may describe any manner of connecting or joining two or more components together. The term “mate” or “mating” may describe any mechanical, thermal, or chemical process that connect or join two or more components together. In the examples disclosed herein, the term “mate” or “mating” may mean welding, soldering, molding, adhering, crimping, folding, double seaming, clamping, snapping, interlocking or otherwise connecting two components. For example, two or more components of the container may be welded, soldered, molded, adhered, crimped, folded, double seamed, clamped, snapped, or interlocked together. “Mating” may also mean connecting or joining at least two components having compatible threaded surfaces. The mating may be permanent or temporary.

As used herein, the terms “bottom-mounted” and “top-mounted” refer to the location of a component within a fixed element. The fixed element may be mated to a container body and may comprise a portion that dispenses the container's contents and a portion that mates with the container body. “Top,” with reference to “top-mounted,” refers generally to a position closest to the end of the fixed element that dispenses the container's contents. For example, a “top-mounted” locknut may refer to a locknut positioned closest to the portion of the fixed element that dispenses the container's contents. “Bottom,” with reference to “bottom-mounted,” refers generally to the position closest to the portion of the fixed element that mates with the container body. For example, a “bottom-mounted” locknut may refer to a locknut positioned closest to the portion of the fixed element that mates with the container body.

As used herein, the terms “bottom-inserted” and “top-inserted” refer to a manner in which a component of the container is introduced to the container body during assembly. The terms may refer to a manner in which a component of a closure system that is mated with the container body is introduced to the container body during assembly. “Top,” with reference to “top-inserted,” refers generally to the position closest the end of the beverage container that dispenses the container's contents. For example, a “top-inserted” locknut may refer to a locknut introduced to the container body at a location where the closure system will be positioned. “Bottom,” with reference to “bottom-inserted,” refers generally to a position nearest the end of the beverage container that is placed on a surface. For example, a “bottom-inserted” locknut may refer to a locknut introduced to the container body through the location of the container body that will be placed on a surface.

In accordance with certain examples, a container is disclosed. The container may be used to hold various contents including, but not limited to consumable goods. The goods may be in the form of at least one of a solid, liquid or gas. In certain examples, the contents may be a food, beverage, or other consumable. In other examples, the contents may be other than a food or beverage, but may still require sanitary conditions and protection from contamination while dispensing.

In accordance with certain examples, a beverage container may comprise a container body and a closure system comprising a removable closure element, and a fixed element secured to the container body. In certain examples, the fixed element may comprise a dispensing portion comprising a spout constructed and arranged to be mated with the removable closure element. The fixed element may also comprise a rim constructed and arranged to secure the dispensing portion to the container body. In certain other examples, the fixed element may comprise a dispensing portion comprising a spout constructed and arranged to be mated with the removable closure element, and a sealing portion constructed and arranged to secure the dispensing portion to the container body. The beverage container may additionally comprise a base plate constructed and arranged to be attached to the container body opposite the closure system.

In accordance with certain examples, the beverage container may be configured to have a container body defining at least a portion of the container that holds the contents of the container. The container body may have an opening for filling and/or dispensing, for example, that may be positioned at a first end portion thereof. The container body may include a plurality of such openings, each with similar or different functions. For example, the container body may include a second opening positioned at a second end portion thereof that may be opposite an opening positioned at a first end portion. The container body may be made from any suitable material for holding, storing, dispensing and/or cooling or heating its contents in a cost-effective manner, ensuring the integrity of the contents, without the risk of contamination. The material may include, but not be limited to, metals and plastics. For example, the container body may be made of glass, steel, tin, aluminum, or plastic materials such as polyethylene terephthalate (PET), high-density polyethylene, low-density polyethylene, polysulfone, polyvinyl chloride, polypropylene, polystyrene, polycarbonate, and the like. The container body may be manufactured as a single component or from multiple components. Container bodies manufactured from a single component may include a seam or joint to provide a structural seal; alternatively, such bodies may be seamless. Container bodies manufactured from multiple components may be assembled by mating or otherwise joining sub-components in various ways. The container body may be formed of a variety of functional and/or ornamental shapes. It will be within the ability of the person of ordinary skill in the art, given the benefit of the disclosure, to select or to design suitable shapes, sizes and materials for construction of the container body disclosed herein. The closure system may also be configured to be filled or refilled.

The container may comprise a closure system. The closure system may be constructed and arranged, in conjunction with the container body, to enclose the various contents inside the container. The closure system may be constructed and arranged to seal the contents inside the container to ensure the integrity of the contents, without the risk of contamination. In certain examples, the closer system may be constructed and arranged to hermetically seal the contents inside the container. The closure system may be configured to provide an opening so that the contents of the container may be dispensed, and to provide a sanitary surface for dispensing and/or consuming the contents. The closure system may be configured to be reclosable to allow a user to open and close the container as desired.

The closure system may be formed of various functional and/or ornamental shapes and sizes to be compatible with and to mate with the container body. The closure system may be made, for example, of any material to provide for sealing of the beverage container, to ensure the integrity of the contents, without the risk of contamination, and for holding, storing, and/or cooling or heating the contents of the beverage container. The closure system may be made of the same material as the container body or a different material. It will be within the ability of the person of ordinary skill in the art, given the benefit of the disclosure, to select or to design suitable shapes, sizes and materials for construction of the closure system disclosed herein.

The closure system may comprise one or more components that enclose and seal the contents inside the container. Closure systems that comprise more than one component may comprise a first component constructed of one material and a second component constructed of a different, compatible material so that the first component and the second component may be mated. Either of the first component or the second component may be the same or different material from the container body, so long as there exists a seal between at least one component of the closure system and the container body. The seal may be formed in various manners, including, but not limited to, a mechanical seal, a thermal seal, a chemical seal, or the like. The components may be pre-assembled prior to securing the closure system to the container body, or may be attached consecutively, either to the container body, to the components of the closure system, or both. For example, a first component of the closure system may be attached to the container body, and the additional components of the closure system may be attached to either the container body, or one or more of the other components, or both. Each component of the closure system may be permanently or temporarily attached to one or more other components of the closure system or the container body, or both. The closure system may be secured to the container body by various methods. The securing may be accomplished by mating.

The closure system may comprise a component that provides the seal between the closure system and the container body to ensure the integrity of the contents of the container, without risk of contamination, in conjunction with the other components of the closure system. The component may be configured to provide a sanitary opening for allowing contents to exit or enter the container. The component may provide a sanitary opening for direct consumption, for example, drinking, from the container. The component may be secured permanently to the container body. The component may be a fixed element that may comprise one or more sub-components. A fixed element may be molded and may comprise one or more sub-components molded into the fixed element. The one or more sub-components may be secured in the molded fixed element to prevent the fixed element and one or more sub-components from rotating relative to one another. A fixed element that comprises more than one sub-component may be preassembled and attached to the container body as a collective fixed element, or may be attached to the container body in consecutive order. The components of the fixed element may be top-mounted or bottom-mounted. The fixed element may be secured to the container body. The securing may be accomplished by mating. Each component of the fixed element may be top-inserted or bottom-inserted, and may be made of the same or different material from each other and from the container body.

As noted above, the fixed element may comprise one or more sub-components. The fixed element may comprise a sub-component that provides an opening for allowing contents to exit or enter the container. The opening may be constructed and arranged to provide a sanitary area for direct consumption from the container. The sub-component may be a dispensing portion constructed and arranged to be compatible with and to be mated with another component or sub-component of the closure system, or to the container body. The dispensing portion may be of various functional and/or ornamental shapes and sizes suitable for dispensing various fluids and solids. The dispensing portion may be constructed and arranged to be suitable for dispensing the contents in a reliable, accurate, and easy manner. In certain examples, the dispensing portion may be constructed and arranged to provide ease in drinking and/or pouring directly from the container. The fixed element may also be constructed and arranged to accept overflow or spillage from the container. It will be within the ability of the person of ordinary skill in the art, given the benefit of the disclosure, to select or to design suitable shapes, sizes and materials for construction of the dispensing portion disclosed herein.

The dispensing portion may comprise a sub-component that has an opening that delivers the contents from the container or admits contents to the container. The component may be constructed and arranged to deliver contents in a reliable, accurate, and easy manner. In certain examples, the component is a spout. The spout may be of various functional and ornamental shapes, sizes, and materials to deliver contents as desired, and be compatible with the other components or sub-components of the closure system and container body. The spout may be constructed and arranged to be mated with another component or sub-component of the closure system. It will be within the ability of the person of ordinary skill in the art, given the benefit of the disclosure, to select or to design suitable shapes, sizes and materials of the spout disclosed herein.

The dispensing portion may comprise a sub-component that secures the fixed element to the container body. The sub-component may be engaged by one or more other components or sub-components of the closure system. The sub-component may be a tab that is engaged to hold the fixed element in place. The sub-component may be one or more tabs that is engaged to hold the fixed element in place by being forced up against the inside of the container body. Alternatively, one or more tabs may be engaged to hold the fixed element in place by being forced up against the outside of the fixed element. The tab may be constructed of any suitable material that will be compatible with the dispensing portion, closure system, and/or container body. The tab may be of various shapes and sizes to facilitate engagement and secure the fixed element to the container body. The tab may be molded into place or put into place.

The fixed element may also comprise a sub-component that secures portions of the fixed element to each other. The sub-component may also secure the fixed element to the container body. The sub-component may secure the fixed element to the container body by mating with the container body, or a component of the closure system. The sub-component may be a locknut, for example, that may be mated with the dispensing portion to secure the fixed element to the container body. The locknut, in another example, may be mated with the spout or another sub-component of the dispensing portion to secure the fixed element to the container body. The locknut may be of various functional and/or ornamental shapes and sizes to secure the desired components of the beverage containers together. It will be within the ability of the person of ordinary skill in the art, given the benefit of the disclosure, to select or to design suitable shapes, sizes and materials of the locknut disclosed herein.

The fixed element may comprise a sub-component to seal and retain the contents inside the container. The sub-component may also secure the fixed element to the container body. The sub-component may be a sealing portion comprising one or more components. The sealing portion may be of various functional and/or ornamental shapes and sizes to provide a seal for retaining contents inside the container and/or for securing the fixed element to the container body. The sealing portion may be constructed of materials that are compatible with the other components of the beverage container. Suitable shapes, sizes and materials for the sealing portion will be readily selected by a person of ordinary skill in the art, given the benefit of the disclosure. Other means may be used alternatively or in conjunction with the above described mechanical elements to secure the fixed element to the container body.

The closure system may comprise a component to secure the fixed element to the container body, and to retain the contents within the container to ensure the integrity of the contents. The component may be constructed and arranged to secure the dispensing portion to the container body. As noted above, beverage containers of the present invention may be manufactured by commercially available processes with minimal retrofitting. The closure element may comprise a component that may be mated and secured to the container body by conventional beverage can manufacturing processes. For example, the component may be mated with the container body to form a seam. The seam may be double seam that provides a hermetic seal. In other examples, the component may be mated with the container body by snapping latches in one component or sub-component into the grooves of another component or sub-component. In certain examples, the component may be a rim. The rim may be constructed and arranged to secure the dispensing portion to the container body. The rim may be made of the same or different material as any one of the components of the container and/or closure system. The rim may have a perimeter that is the same or different shape as the perimeter of the top portion of the container body. For example, the rim may have a circular outer circumference, and may have a diameter the same as or larger than the diameter of the top portion of the container body. The rim may comprise at least one opening. The opening may be constructed and arranged of a shape, size and material to ultimately allow the contents of the container to be dispensed smoothly and efficiently from the container. The opening may allow for a dispensing portion or spout to fit within the opening. The opening may be a pre-determined shape, for example, the opening may be in the shape of a circle that is centered with respect to the outer perimeter of the rim. In other examples, the opening may be off-set with respect to the outer perimeter of the rim. The shape of the opening may be the same or different shape as the outer perimeter of the rim. The shape of the opening of the rim may be the same or different shape as the outer perimeter of the spout.

The closure system may comprise a component that provides a closure to the beverage container. The component may ensure the integrity of the contents and enclose the contents of the container, without risk of contamination, during holding, storing, shipping, dispensing, and/or cooling or heating the contents. Additionally, the component protects the dispensing portion of the container from the environment, thereby ensuring sanitary conditions until a user opens the container. The component may be a removable closure element that may seal off the contents of the container from the environment initially, and, subsequent to opening, may be used again to seal off contents and further protect the dispensing portion from the environment. The removable closure element may be constructed and arranged to mate with one or more components of the fixed element, the container body or both. In certain examples, the removable closure element may be constructed and arranged to be mated with the dispensing portion or the spout. The removable closure element may be of various functional and/or ornamental shapes and sizes to be mated with the other components of the closure system and/or container body, and may be constructed of a material suitable for such purposes. The removable closure element may be sized and shaped to facilitate opening and closing of the container. The removable closure element may provide a surface for indicia for labeling the contents of the container, marketing, or the like. The removable closure element may provide a surface that is easily printed on using conventional printing methods. The removable closure element may comprise one or more components that may be permanently or temporarily attached to each other.

The closure system may comprise a tethered portion so that the removable closure element may be connected to the fixed element, the container body, or both. The tethered portion may be constructed and arranged of various shapes, sizes and materials so that when the removable closure element is removed it remains attached to the beverage container.

The container may comprise a component to enclose the contents of the beverage container. The component may be used to close a container body and to ensure the integrity of the contents of the container, without risk of contamination. In certain examples, the component may be constructed and arranged to attach to the container body. The component may be a base plate. The base plate may be attached opposite the closure system. The base plate may be constructed of materials compatible with the container body, such that the base plate may be mated with the container body. In some examples, the base plate may be flat. In certain other examples, the base plate may be domed to protrude into the container to alleviate pressure within the container if the contents are sealed under pressure or, for example, are carbonated. Attachment of the base plate to the container body may occur by temporarily or permanently mating the base plate and the container body.

To facilitate stacking of the containers for more convenient and cost-effective shipping and storing, the top of the removable closure element may be constructed and arranged to accept the bottom of another container body, or the base plate attached to another container body. In other examples, a side of the container body may be constructed and arranged to accept a side of another container body to facilitate stacking of the containers.

In accordance with certain examples, a method of making a beverage container comprises providing a container body. In certain examples, the method may comprise disposing a closure system comprising a removable closure element and a fixed element comprising a dispensing portion and a rim to a first end of the container body having a first edge, and securing the rim to the first edge of the container body.

In accordance with certain examples, a method of making a beverage container comprises providing a container body comprising a first opening and a second opening opposite a first opening, securing a closure system comprising a removable closure element and a fixed element, and attaching a base plate to the second opening of the container body.

A container body may be provided of various functional and/or ornamental shapes and sizes suitable for holding, storing, handling, and/or cooling or heating the contents of the beverage container. Conventional manufacturing processes as described above are used for producing beverage can bodies may be used for providing a container body. The closure system may be disposed on the container body by placing, dropping, depositing, or the like. This may be accomplished through automated processes or manually. Securing may occur to ensure the integrity of the contents of the container through mating of the container body to the closure system. Mating may occur between the container body and the rim. Mating may also occur between various components and sub-components of the closure system and container body. The securing may also occur using conventional methods of manufacturing beverage cans, for example, by forming a double seam. A flange of the rim may curl around a first edge of the container body to form a partial seam. The partial seam may be crimped and flattened for form a hermetic seal.

To assemble the beverage container, all or part of the closure element may be pre-assembled to be mated with the container body or inserted through the container body and may be compatible with conventional manufacturing processes of an aluminum can. Alternatively, portions of the fixed element may be mated to each other and the container body without being pre-assembled. In certain examples, at least a portion of the fixed element may be moved through the second opening to secure the fixed element to the first opening. Moving may be accomplished by automatic processes, or manually.

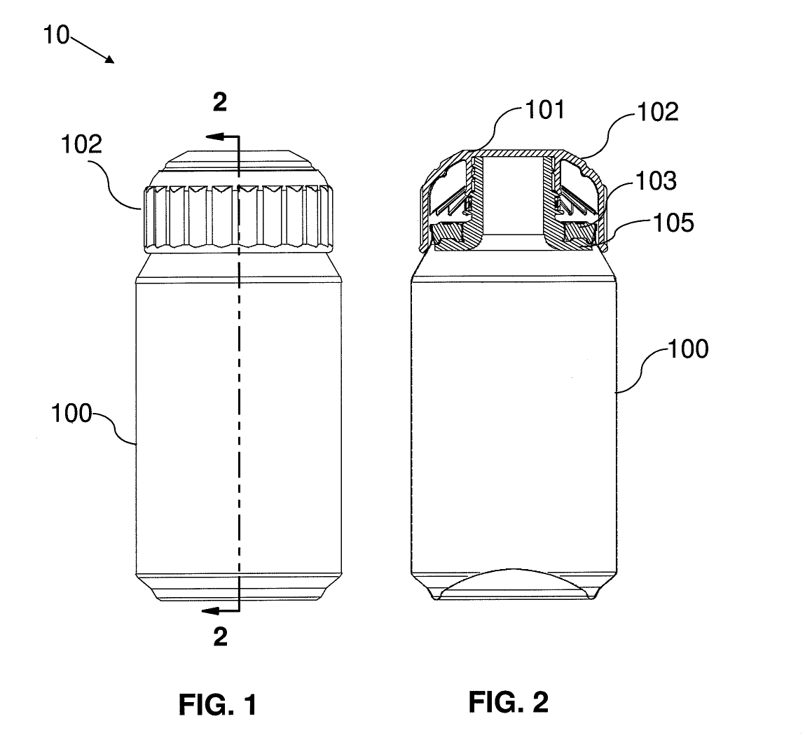

In one embodiment, FIGS. 1 and 2 illustrate a beverage container 10 in which a container body 100 made from a conventional manufacturing process is used. Container body 100 is attached to closure system 102. Closure system 102 comprises removable closure element 101 which encloses the remaining components of the beverage container's closure system 102. FIG. 2 is a cross-sectional view of the beverage container, and illustrates a beverage container 10 comprising a top-mounted, top-inserted locknut 103 and bottom-mounted, top-inserted dispensing portion 105.

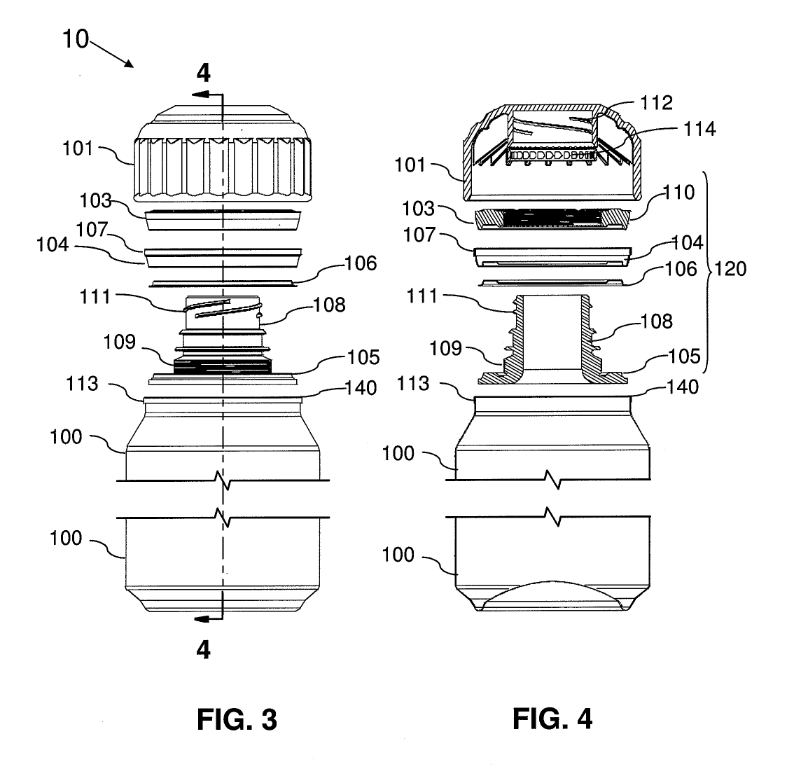

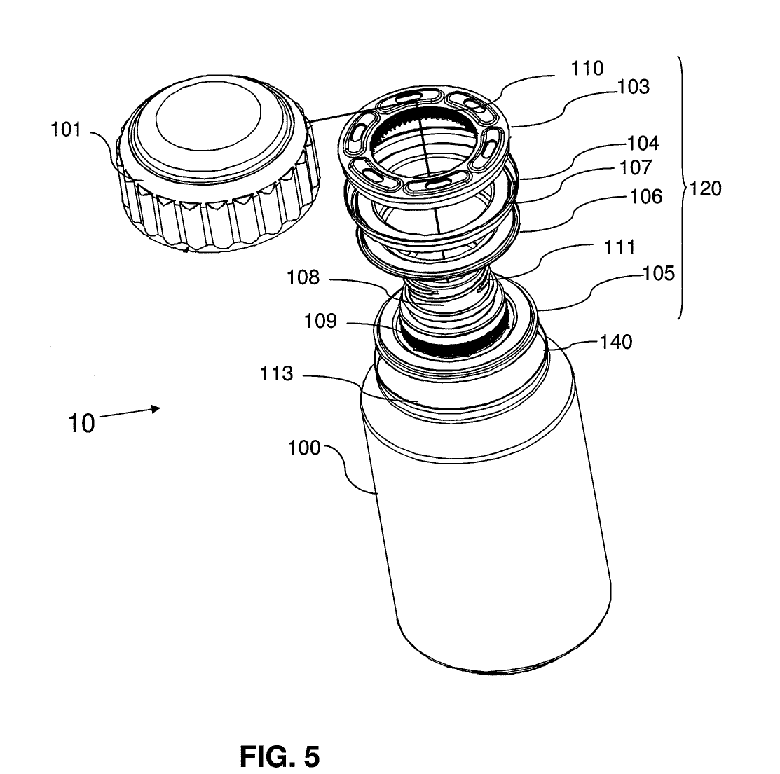

As illustrated in the various exploded views of FIGS. 3-5, beverage container 10 of FIGS. 1 and 2 comprises multiple components. As shown, end 140 of container body 100 may receive the components of fixed element 120. Fixed element 120 may be assembled by placing gasket 106 on dispensing portion 105 followed by rim 104. Locknut 103 is then screwed into place on dispensing portion 105 by mating compatible threaded surface 109 of dispensing portion 105 and threaded surface 110 of locknut 103. Fixed element 120 may then be secured by mating flange 107 of rim 104 with edge 113 of container body 100. Removable closure element 101 may be secured on spout 108 having threaded surface 111 by mating with threaded surface 112 on removable closure element 101 to close beverage container 10. Removable closure element 101 comprises safety seal 114. When the user first opens the beverage container by twisting removable closure element 101, safety seal 114 will break away from removable closure element 101, and will remain on spout 108.

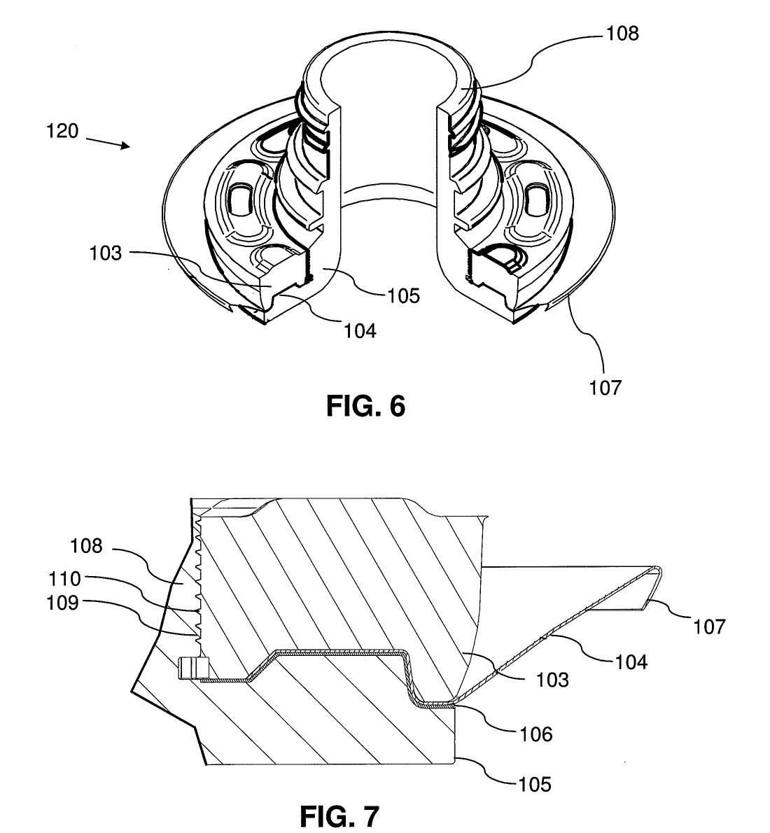

FIGS. 6 and 7 illustrate perspective and cross-sectional views of fixed element 120 of beverage container 10 (not shown in FIGS. 6 and 7) prior to attaching to container body 100 (not shown in FIGS. 6 and 7). Fixed element 120 comprises locknut 103 mated to dispensing portion 105 having spout 108. Rim 104, having flange 107, is disposed between locknut 103 and dispensing portion 105. FIG. 7 illustrates threaded surface 109 of dispensing portion 105 mated with threaded surface 110 of locknut 103. FIG. 7 also illustrates gasket 106 disposed between rim 104 and dispensing portion 105. Fixed element 120 may be positioned on end 140 (not shown in FIGS. 6 and 7) of container body 100, and slides into place with a portion of fixed element 120 inside container body 100. Flange 107 of rim 104 hooks over edge 113 (not shown in FIGS. 6 and 7) of container body 100. Flange 107 may be curled around edge 113, and crimped and flattened against container body 100 to form a double seam hermetic seal.

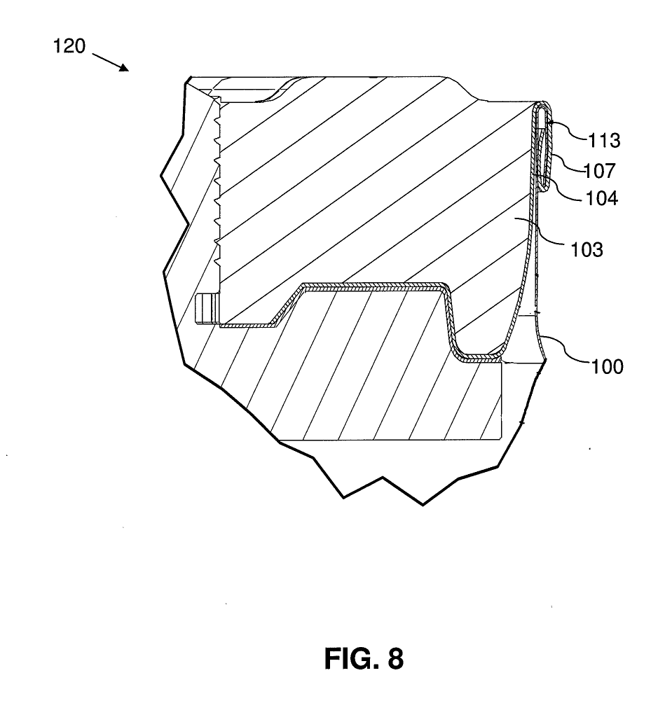

FIG. 8 illustrates a cross-sectional view of fixed element 120 after attaching it to container body 100. Edge 113 of container body 100 is folded outward by flange 107 of rim 104 such that edge 113 is approximately parallel to container body 100. Flange 107 is curved around edge 113 to secure edge 113 once flange 107 is crimped and flattened against container body 100. This attachment process to form a double seam hermetic seal may be performed using conventional can manufacturing processes.

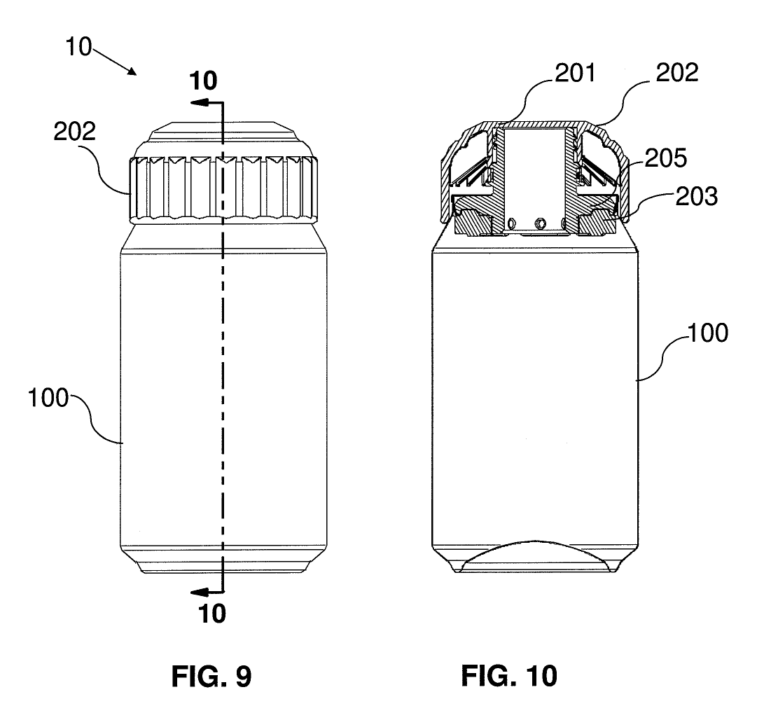

In another embodiment, FIGS. 9 and 10 illustrate a beverage container 10 in which container body 100 made from a conventional manufacturing process is used. Container body 100 is attached to closure system 202. Closure system 202 comprises removable closure element 201 which encloses the remaining components of the beverage container's closure system 202. FIG. 10 is a cross-sectional view, and illustrates a beverage container 10 comprising bottom-mounted, top-inserted locknut 203 and a top-mounted, top-inserted dispensing portion 205.

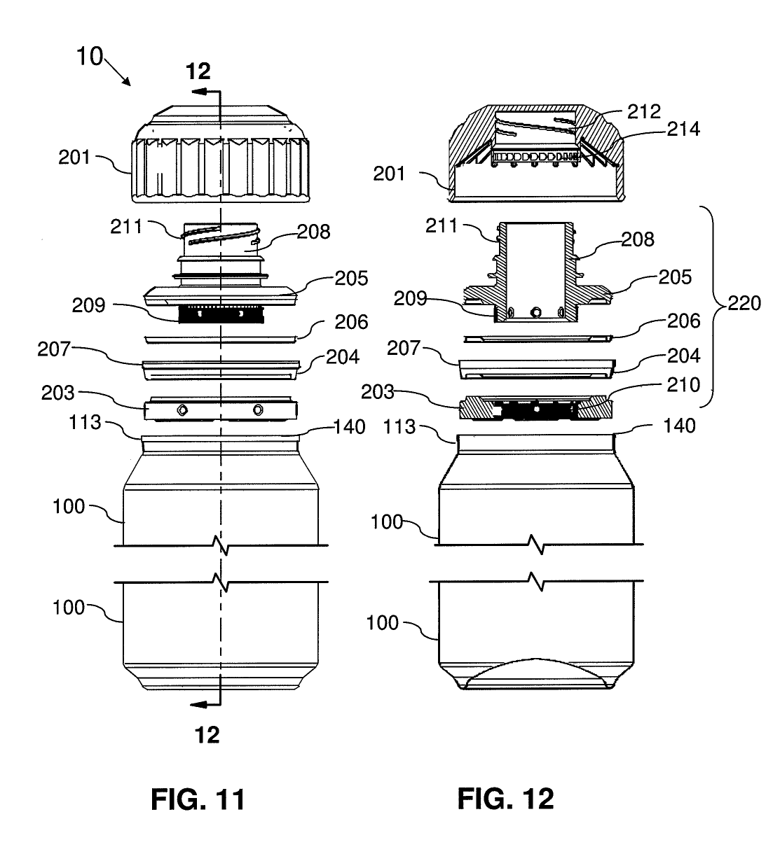

As illustrated in the exploded views of FIGS. 11 and 12, beverage container 10 of FIGS. 9 and 10 comprises multiple components. Container body 100 is mated with fixed element 220 by inserting fixed element 220 into end 140 of container body 100. Fixed element 220 may be assembled by placing rim 204 on locknut 203 followed by gasket 206 on rim 204 and dispensing portion 205 on gasket 206. Threaded surface 209 of dispensing portion 205 is compatible with threaded surface 210 of locknut 203. Locknut 203 is then screwed into place on spout 208 to complete the assembly of fixed element 220. Fixed element 220 may be attached to container body 100 by securing rim 204 having flange 207 to container body 100. Flange 207 of rim 204 is mated with edge 113 of container body 100 to form a double seam hermetic seal, as discussed above with reference to FIGS. 6-8. Removable closure element 201 is screwed into place on spout 208 by mating threaded surface 211 of spout 208 with threaded surface 212 of removable closure system 201 to close beverage container 10. Removable closure element 201 comprises safety seal 214. When the user first opens the beverage container by twisting removable closure element 201, safety seal 214 will break away from removable closure element 201, and will remain on spout 208.

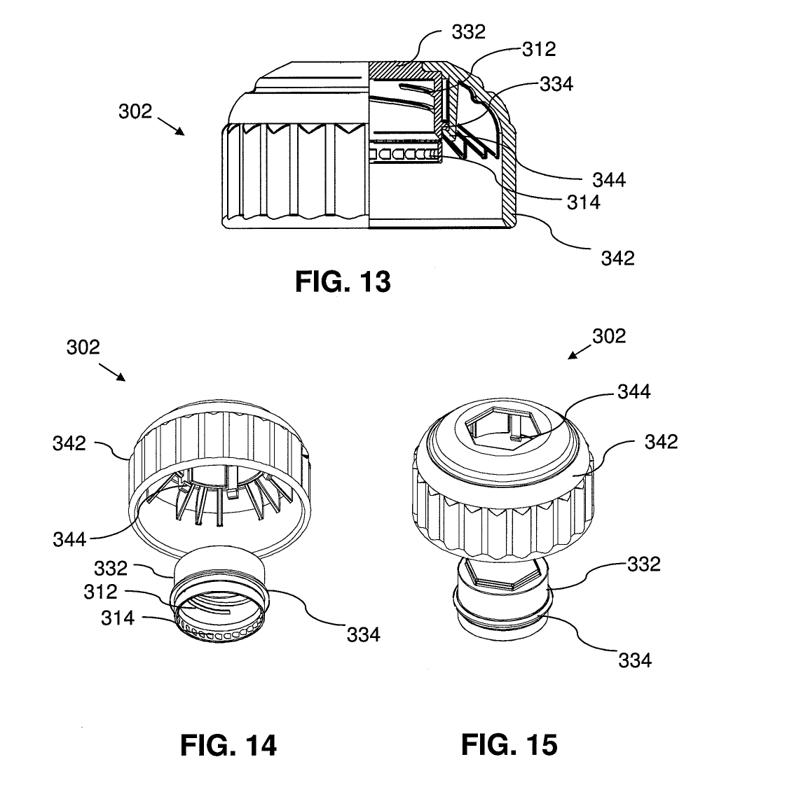

In another embodiment, FIGS. 13-15 illustrate cross-sectional and perspective views of a two-component removable closure element 302 that may be compatible with the fixed element and the container body of any of the examples disclosed herein. The two-component removable closure element comprises a first component 332 and a second component 342. First component 332 has a threaded surface 312 that is compatible with the threaded surface on a spout (not shown in FIGS. 13-15). By moving first component 332 into second component 342 or by moving second component 342 onto first component 332, lip 344 of second component 342 snaps over ridge 334 of first component 332. The beverage container having removable closure element 302 may be shipped, stored and sold with first component 332 and second component 342 to ensure sanitary conditions and cleanliness of the dispensing portion of the beverage container. Subsequent to opening the container, first component 332 may be used alone or in combination with second component 342 to reclose the beverage container. First component 332 comprises safety seal 314. When the user first opens the beverage container by twisting removable closure element 302, safety seal 314 will break away from first component 332, and will remain on a spout.

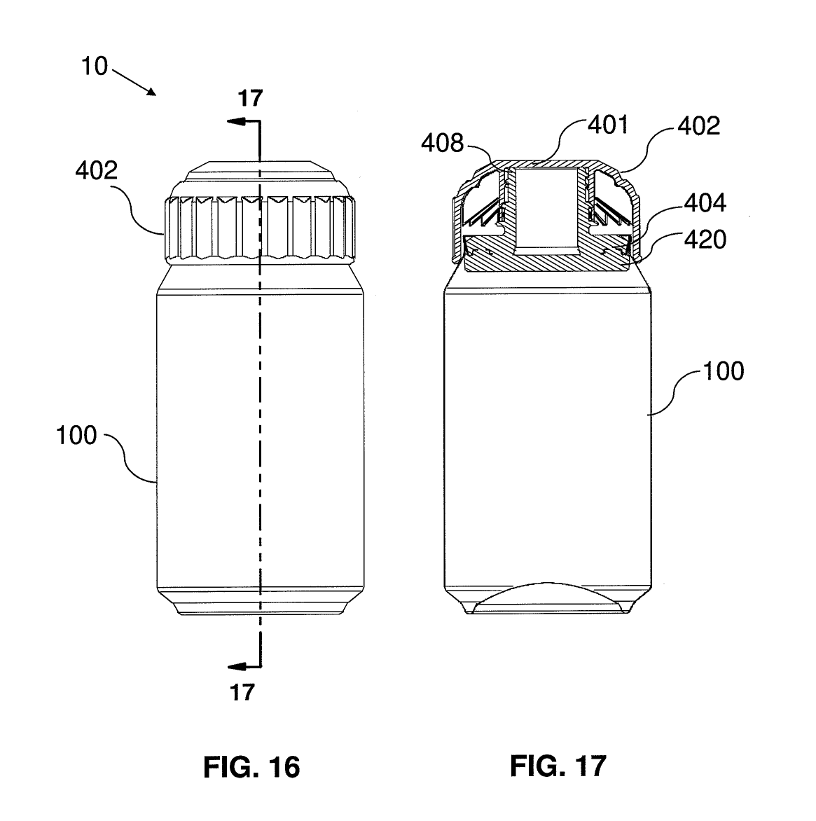

In another embodiment, FIGS. 16-19 illustrate beverage container 10. Container body 100 is attached to closure system 402. Closure system 402 comprises removable closure element 401 which encloses the remaining components of the beverage container's closure system 402. In accordance with this example, the closure system 402 comprises a one-piece, top-mounted, top-inserted molded fixed element 420 comprising rim 404 molded into fixed element 420. Molded fixed element 420 also comprises spout 408 having threaded surface 411 that is compatible with threaded surface 412 of removable closure element 401.

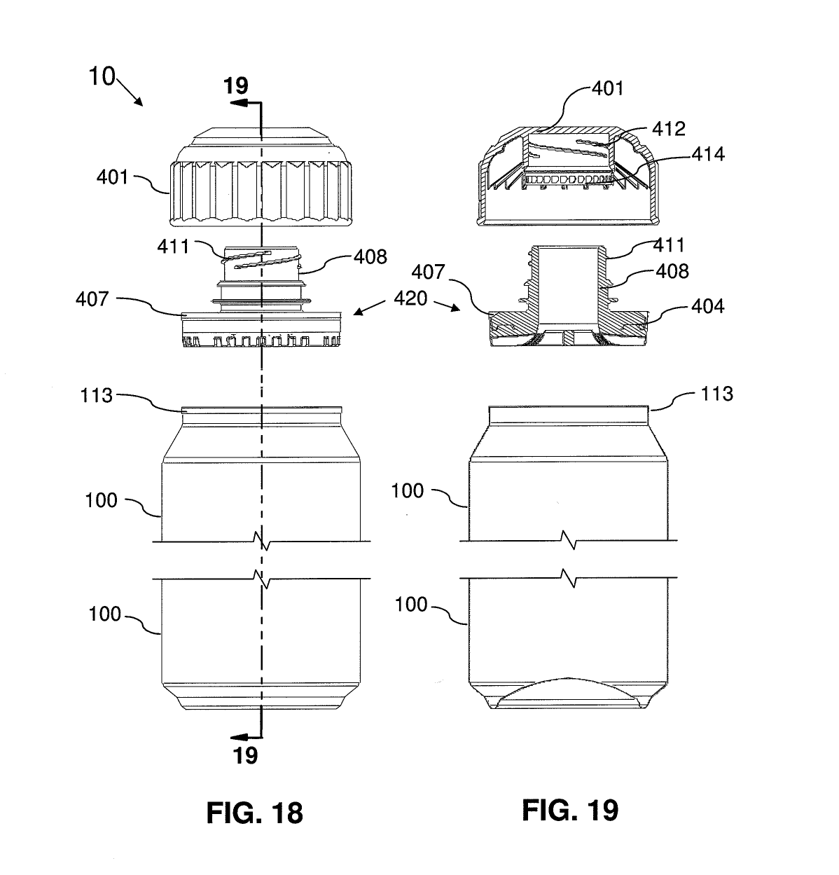

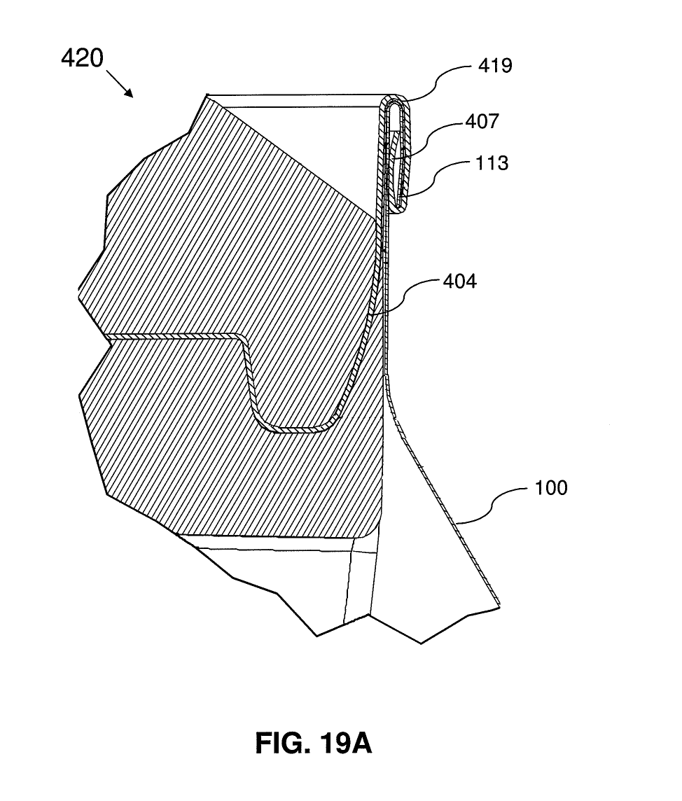

FIG. 19A illustrates a cross-sectional view of a detail of fixed element 420 after attaching it to container body 100. Flange 407 of rim 404 may be mated with edge 113 of container body 100 to secure fixed element 420 to container body 100, as discussed above with reference to FIGS. 6-8. A portion 419 of fixed element 420 may also be incorporated in the double seam hermetic seal. Referring to FIGS. 18 and 19, removable closure element 401 is screwed into place on spout 408 by mating threaded surface 411 with threaded surface 412 to enclose the beverage container. Removable closure element 401 comprises safety seal 414. When the user first opens the beverage container by twisting removable closure element 401, safety seal 414 will break away from removable closure element 401, and will remain on spout 408.

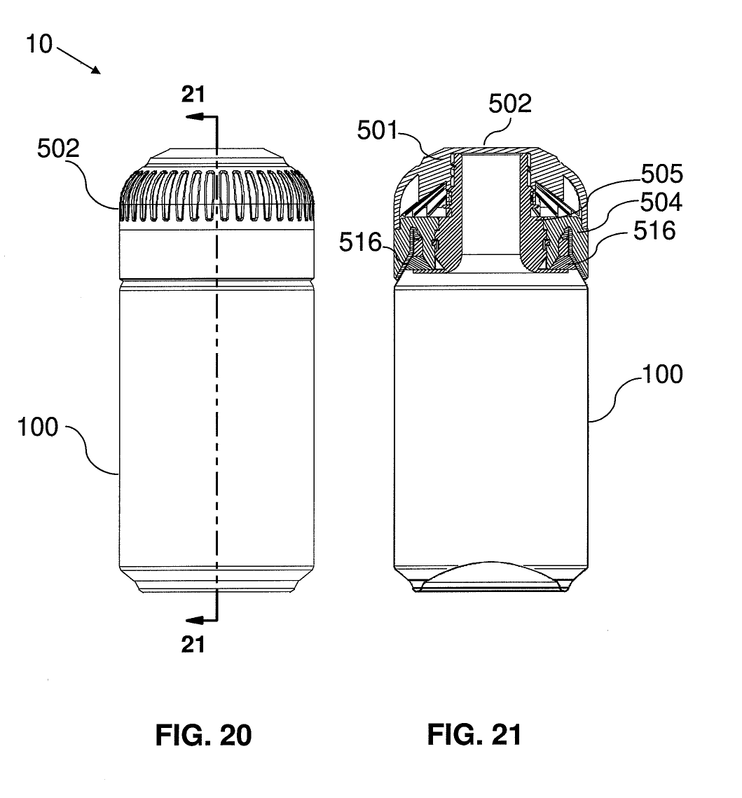

In another embodiment, FIGS. 20 and 21 illustrate a beverage container 10 comprising container body 100 and closure system 502. Closure system 502 comprises removable closure element 501 which encloses the remaining components of the beverage container's closure system 502. FIG. 21 is a cross-sectional view of the beverage container 10, and illustrates beverage container 10 comprising bottom-mounted, top-inserted dispensing portion 505 and top-mounted, top-inserted rim 504. FIG. 21 also illustrates tabs 516.

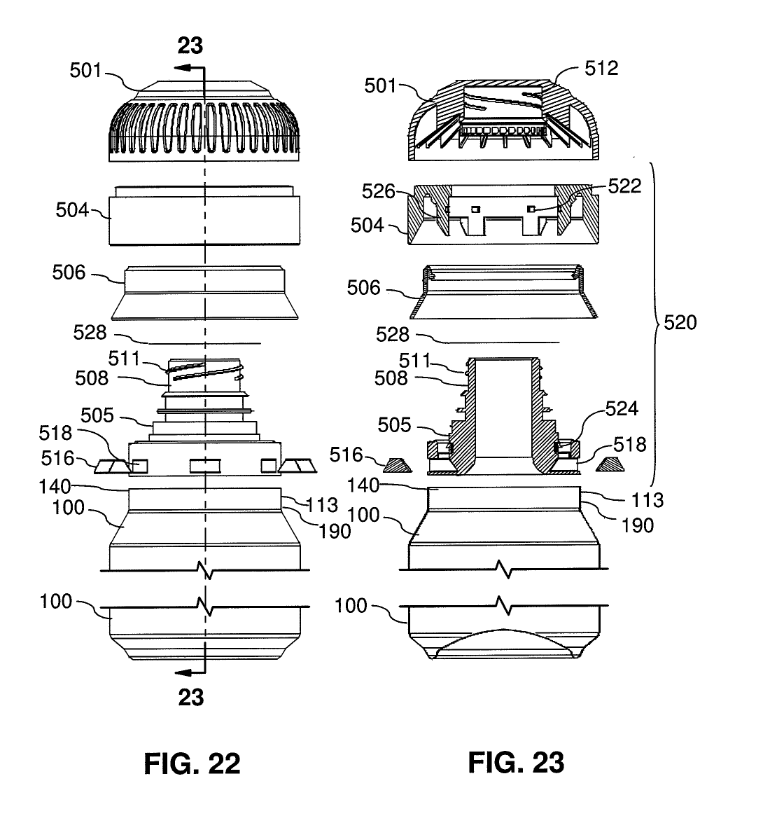

As illustrated in the exploded views of FIGS. 22 and 23, container body 100 of FIGS. 21 and 22 having edge 113 and outer surface 190 is mated with fixed element 520 by inserting a portion of the fixed element 520 into end 140. In this embodiment, fixed element 520 comprises rim 504, gasket 506, o-ring 528, and dispensing portion 505. Rim 504 further comprises six pins 526 and six grooves 522. Dispensing portion 505 further comprises spout 508, six tabs 516, six slots 518, and six latches 524. Spout 508 has threaded surface 511 that is compatible with threaded surface 512 of reclosable closure element 501.

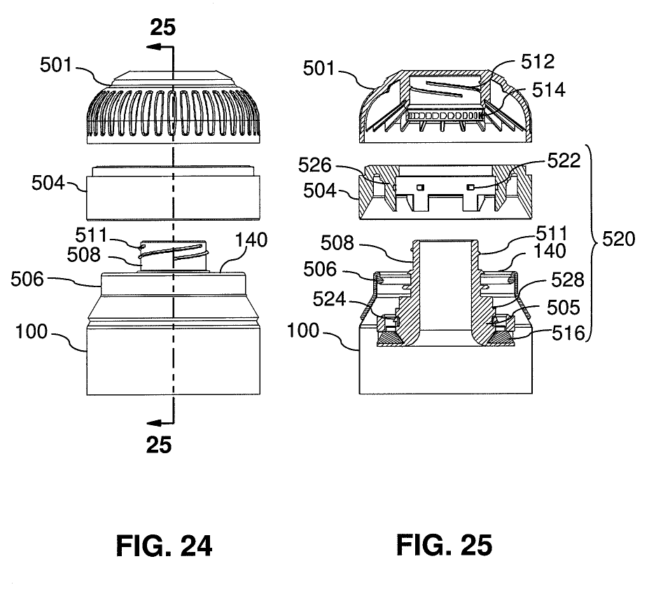

FIGS. 24 and 25 illustrate a partial assembly of fixed element 520. Tabs 516 are inserted into slots 518 (shown in FIGS. 22 and 23) of dispensing portion 505. Dispensing portion 505 may then be held in place at least partially inside container body 100 at end 140. Gasket 506 may then be placed to conform to edge 113 (shown in FIGS. 22 and 23) of container body 100, such that a portion of gasket 506 is conforming to outer surface 190 (shown in FIGS. 22 and 23) of container body 100.

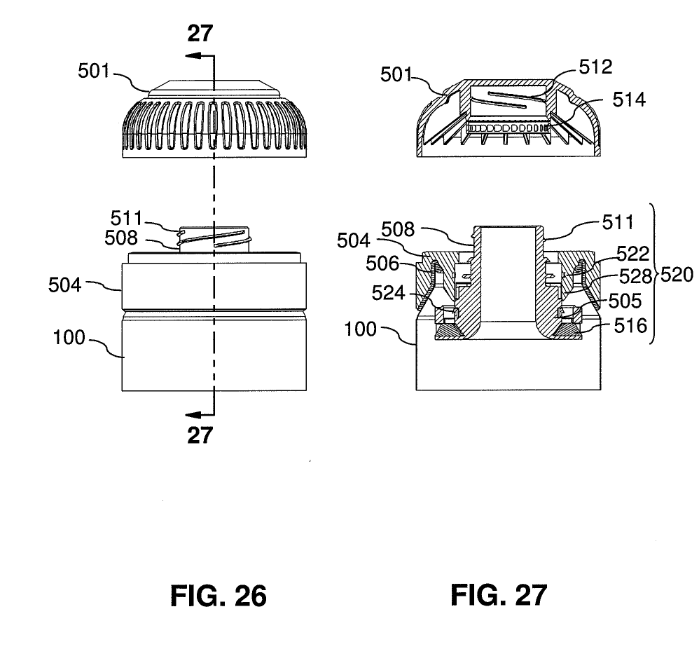

FIGS. 26 and 27 illustrate further partial assembly of fixed element 520. Rim 504 is placed on gasket 506 in preparation for engaging dispensing portion 505 with rim 504. This engagement will thereby secure fixed element 520 to container body 100. To engage dispensing portion 505 with rim 504, rim 504 is held in place on gasket 506 and edge 113 (not shown in FIGS. 26-27). Dispensing portion 505 may then be moved towards rim 504 and end 140 (not shown in FIGS. 26-27). As this occurs, pins 528 engage tabs 516, pushing them outward towards the inner surface of container body 100 to hold fixed element 520 in place. Additionally, latches 524 are mated with compatible grooves 522.

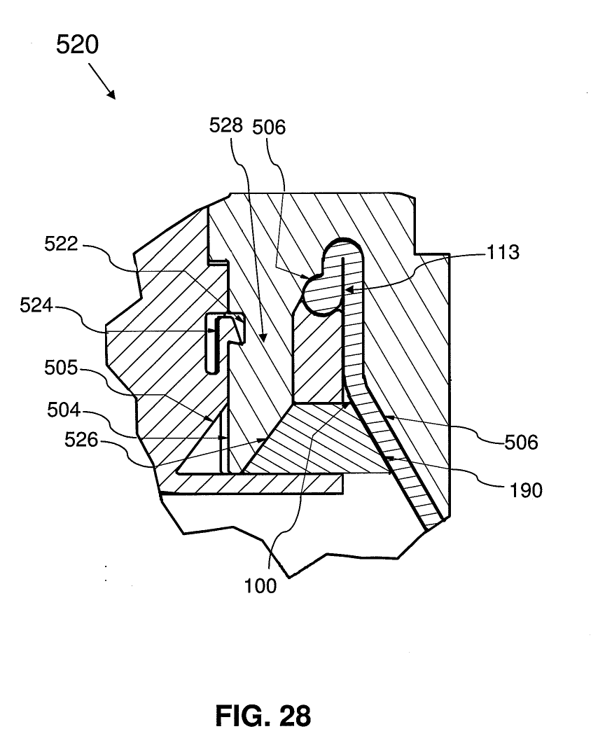

As illustrated in the cross-sectional view of FIG. 28, depicting a detail of fixed element 520 secured to container body 100 of FIGS. 20-27, rim 504 rests on edge 113 and partially rests on outside surface 190 of container body 100, with gasket 506 disposed between rim 504 and container body 100. Latch 524 is securely fitted into groove 522 to secure the rim 504 to dispensing portion 505. Pin 528 of rim 504 is also in place to wedge tab 526 between pin 528 and container body 100.

As shown in FIGS. 22-27, removable closure element 501 may be screwed into place by mating compatible threaded surface 512 of removable closure element 501 with threaded surface 511 of spout 508. Removable closure element 501 comprises safety seal 514. When the user first opens the beverage container by twisting removable closure element 501, safety seal 514 will break away from removable closure element 501, and will remain on spout 508.

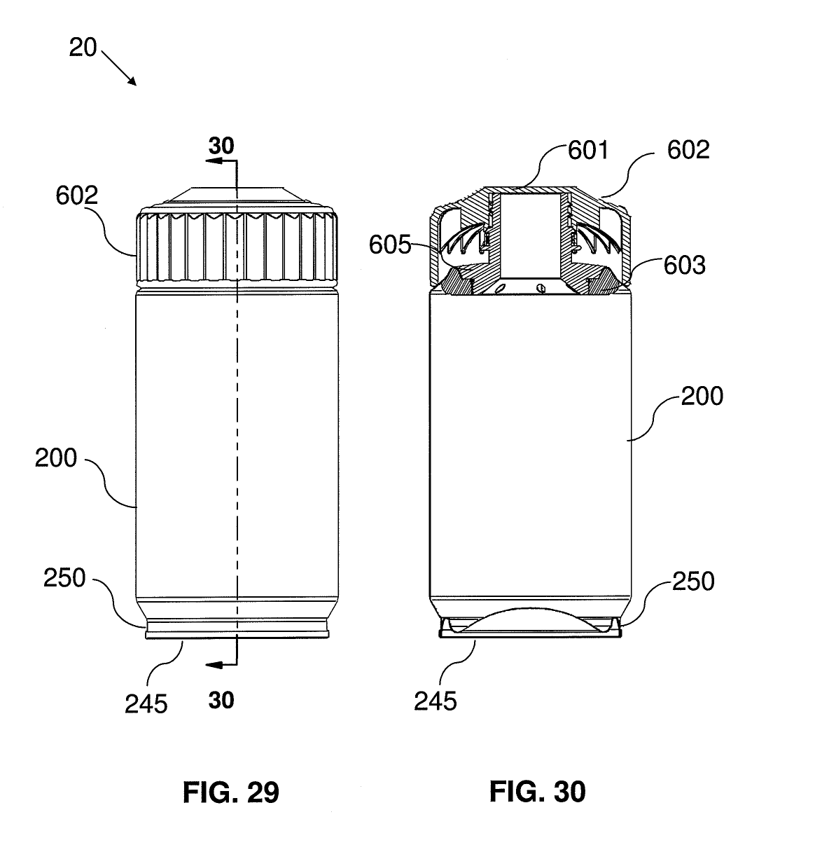

In another embodiment, FIGS. 29-30 illustrate beverage container 20 comprising container body 200, base plate 250, and closure system 602. Base plate 250 is attached at end 245 opposite closure system 602. Base plate 250 may protrude inwards when attached to container body 200 so that it may withstand internal pressure from, for example, a carbonated beverage. Closure system 602 comprises removable closure element 601 which encloses the remaining components of the beverage container's closure system 602. FIG. 30 is a cross-sectional view of beverage container 20, and illustrates a beverage container comprising bottom-mounted, bottom-inserted locknut 603, and top-mounted, top-inserted dispensing portion 605.

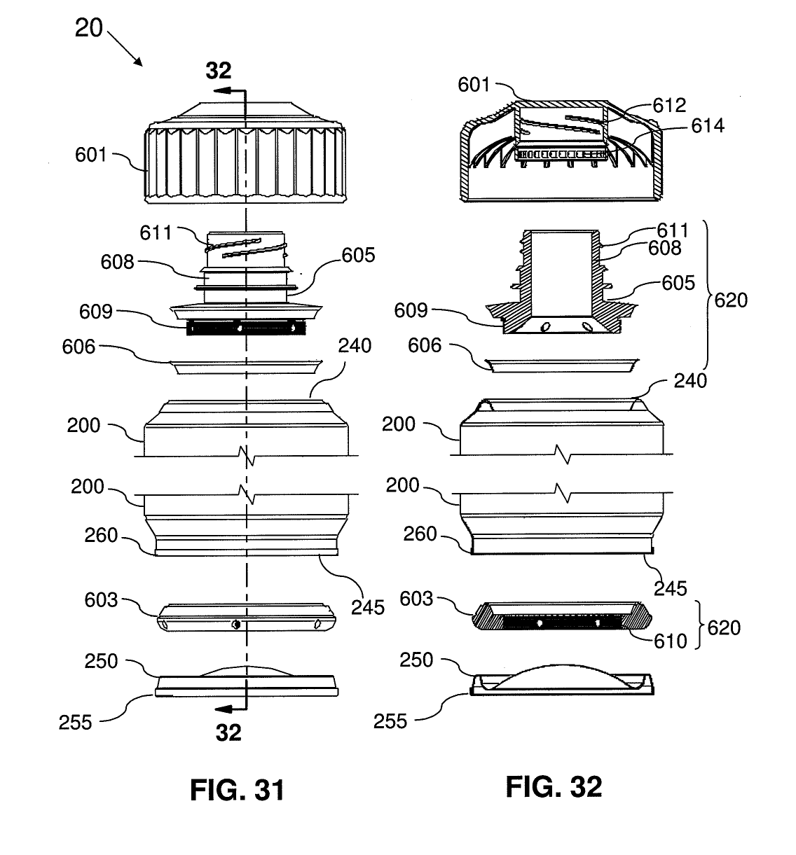

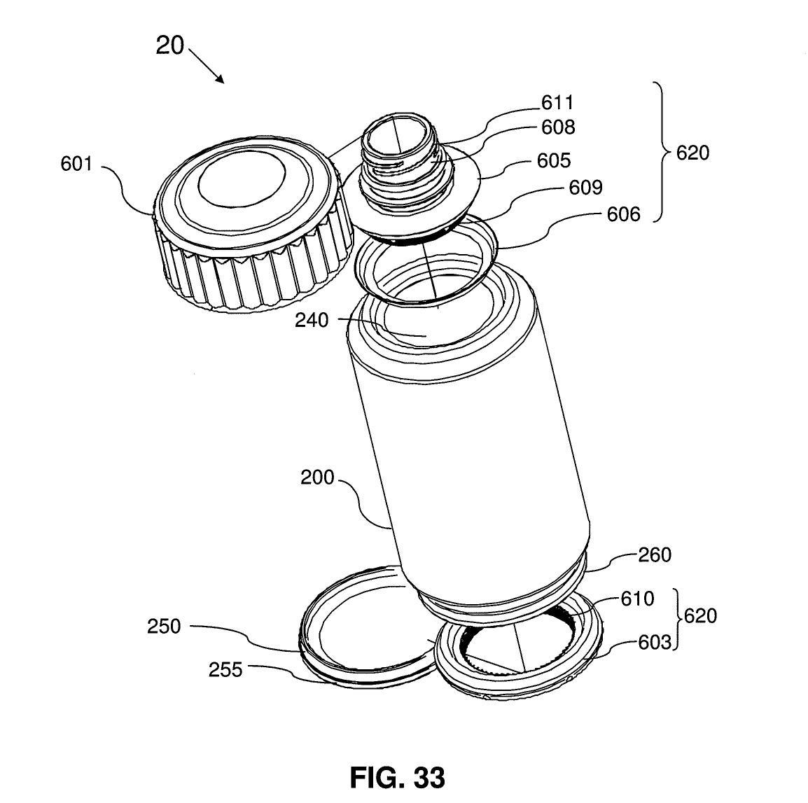

As illustrated in the exploded views of FIGS. 31-33, container body 200 is mated with fixed element 620 by inserting a portion of fixed element 620 into end 240, and inserting another portion of fixed element 620 into end 245. Dispensing portion 605 and gasket 606 are inserted at end 240 to be mated at end 240 with locknut 603. Dispensing portion 605 has threaded surface 609 that is compatible with threaded surface 610 on locknut 603. Dispensing portion 605 comprises spout 608 having threaded surface 611 that is compatible with threaded surface 612 of the removable closure element 601. Removable closure element 601 comprises safety seal 614. When the user first opens the beverage container by twisting removable closure element 601, safety seal 614 will break away from removable closure element 601, and will remain on spout 608.

After assembling and attaching fixed element 620 and removable closure element 601, contents may then be added to the container body 200 through end 245. Base plate 250 may then be attached to end 245 of container body 200 to enclose the contents within beverage container 20. Flange 255 of base plate 250 is mated with edge 260 of container body 200 to secure base plate 250 to container body 200. Flange 255 of base plate 250 hooks around edge 260 of container body 200. Flange 255 may be curled around bottom edge 260, and compressed and flattened against container body 200 to form a double seam hermetic seal.

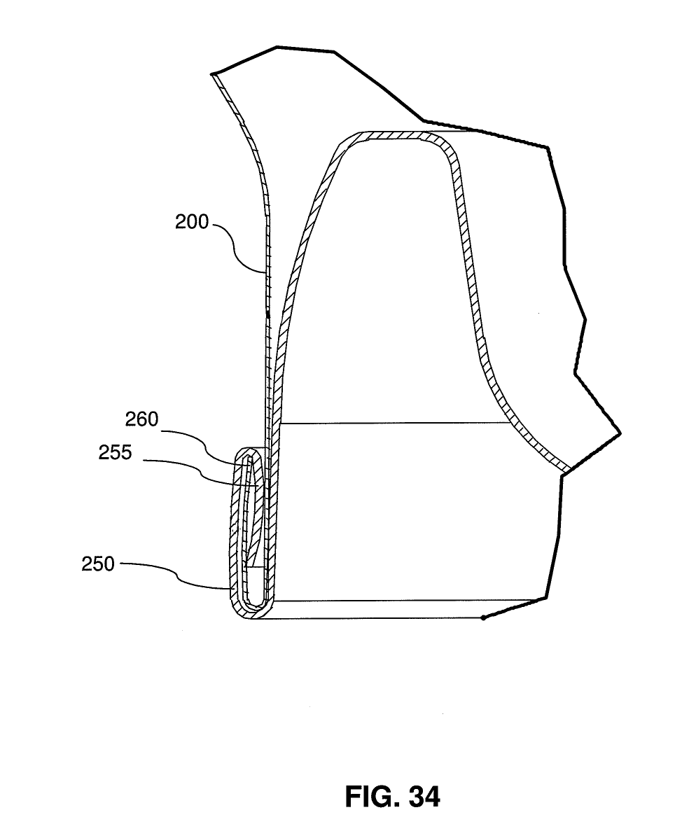

FIG. 34 illustrates a cross-sectional view of the mating of base plate 250 to container body 200. Edge 260 of container body 200 is folded outward by flange 255 of base plate 250 such that edge 260 is approximately parallel to container body 200. Flange 255 is curved around edge 260 to secure edge 260 once flange 255 is crimped and flattened against container body 200. This attachment process to form a double seam hermetic seal may be performed using conventional can manufacturing processes.

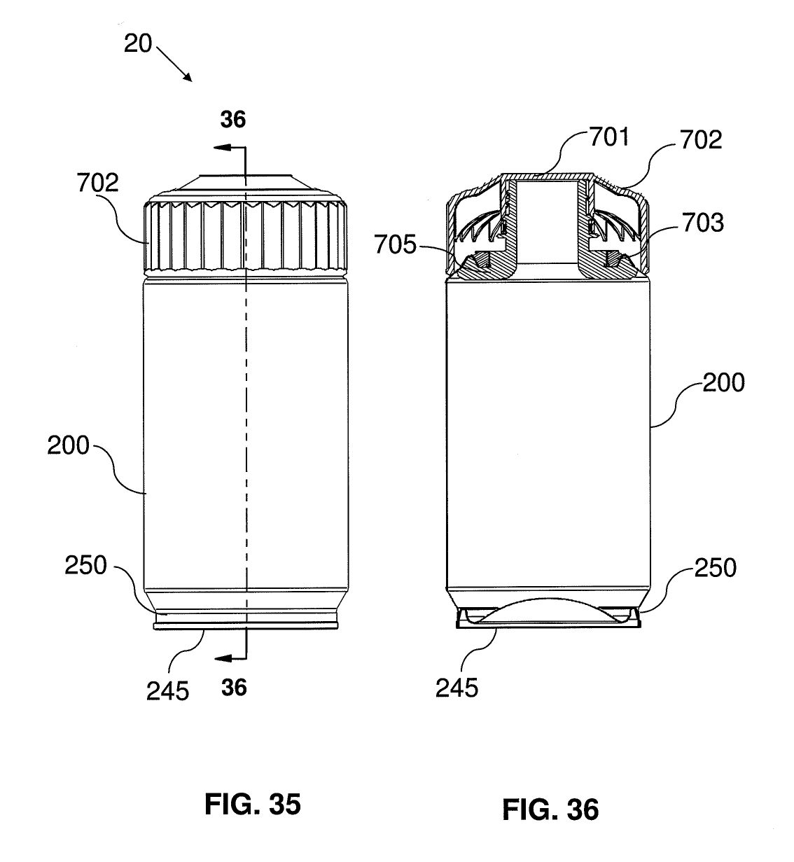

In another embodiment, FIGS. 35 and 36 illustrate beverage container 20 comprising container body 200, base plate 250, and closure system 702. Base plate 250 is attached at end 245 of container body 200, opposite closure system 702. Base plate 250 may protrude inwards when attached to container body 200 so that it may withstand internal pressure from, for example, a carbonated beverage. Closure system 702 comprises removable closure element 701 which encloses the remaining components of the beverage container's closure system 702. FIG. 36 is a cross-sectional view of beverage container 20, and illustrates beverage container 20 comprising top-mounted, top-inserted locknut 703, and bottom-mounted, bottom-inserted dispensing portion 705.

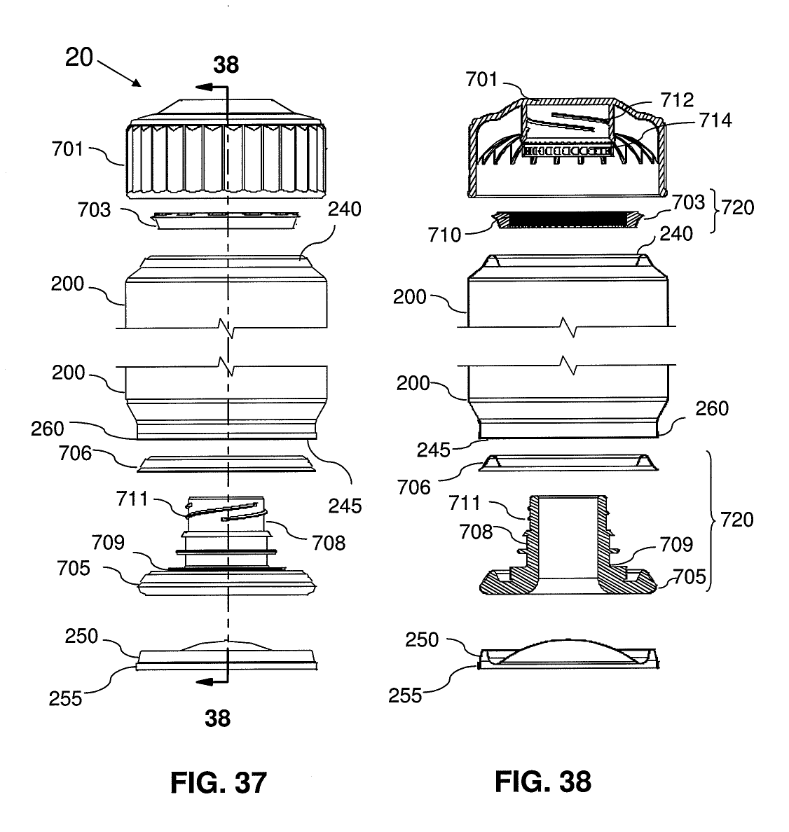

As illustrated in the exploded views of FIGS. 37 and 38, beverage container 20 of FIGS. 35 and 36 comprises multiple components. The container body 200 is mated with fixed element 720 by inserting locknut 703 into end 240 and inserting gasket 706 and dispensing portion 705 into end 245. The components of fixed element 720 are secured at end 240. Locknut 703 is screwed into place by mating threaded surface 709 of dispensing portion 705 with threaded surface 710 of top locknut 703. Removable closure element 701 is screwed into place on spout 708 by mating threaded surface 711 with threaded surface 712 to enclose the beverage container. Removable closure element 701 comprises safety seal 714. When the user first opens the beverage container by twisting removable closure element 701, safety seal 714 will break away from removable closure element 701, and will remain on spout 708.

After assembling and attaching fixed element 720 and removable closure element 701, contents may then be added to the container body 200 through end 245. Base plate 250 may then be attached to end 245 of container body 200 to enclose the contents of the container as described above with reference to FIG. 34. Flange 255 of base plate 250 is mated with edge 260 of container body 200 to secure base plate 250 to container body 200. Flange 255 of base plate 250 hooks around edge 260 of container body 200. Flange 255 may be curled around edge 260, and compressed and flattened against container body 200 to form a double seam hermetic seal.

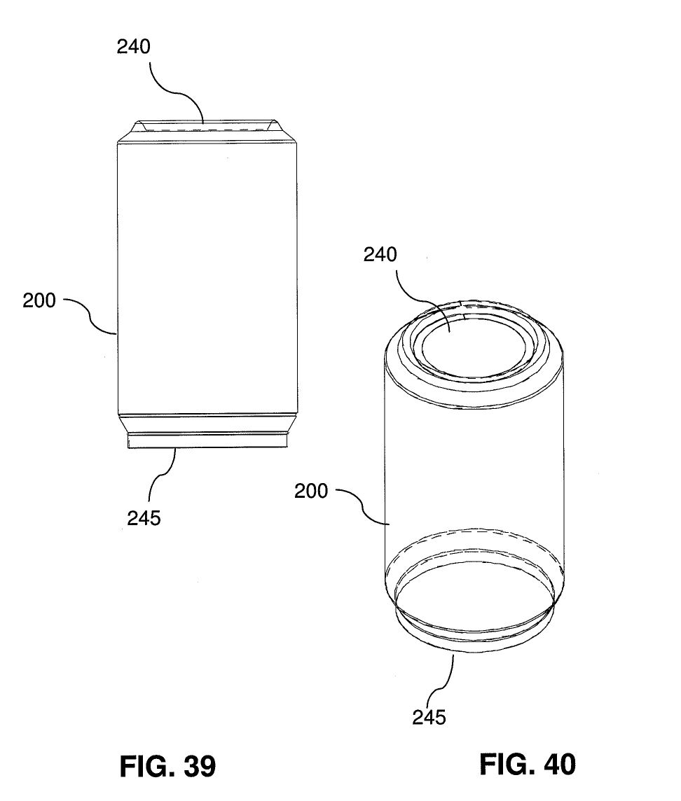

FIGS. 39 and 40 illustrate how container body 200 may be constructed. In accordance with certain examples, container body 200 may be made by conventional can manufacturing methods as described above. Container body 200 comprises open container body end 245 and covered container body end 240. In certain examples, container body 200 is made by removing covered container body end 240. This allows components of the fixed element to be positioned in place of container body end 240, while other components may be inserted through end 245 and secured into place at end 240. Removing covered container body end 240 would require an additional step to the conventional beverage can manufacturing process, but would allow container body end 240 to be recycled and save on cost of materials.

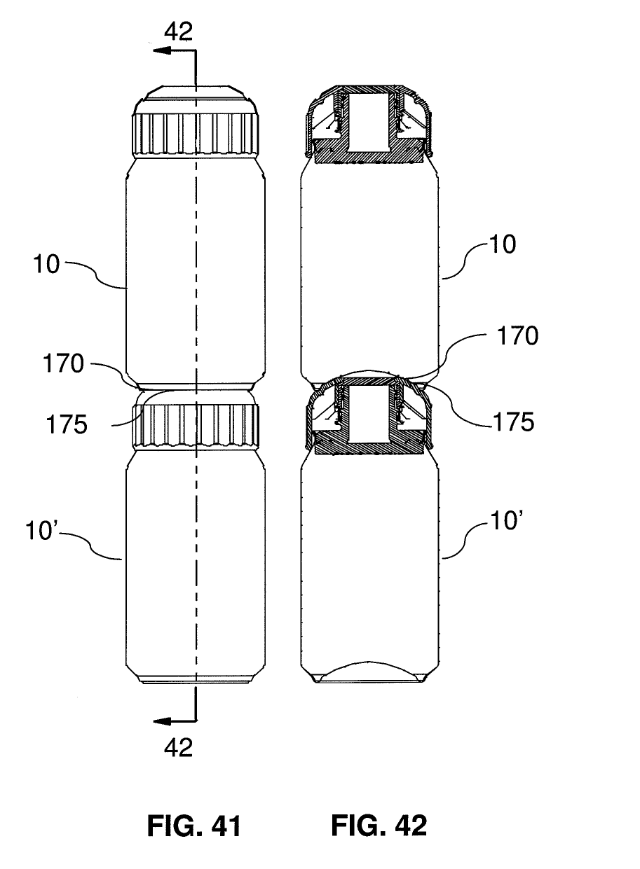

FIGS. 41 and 42 illustrate two beverage containers, beverage container 10 stacked on top of another beverage container 10′. In this example, bottom surface 170 of beverage container 10 conforms to top surface 175 of beverage container 10′. It will be within the ability of the person of ordinary skill in the art, given the benefit of the disclosure, to select or to design suitable surfaces for ease of stacking of the beverage containers disclosed herein.

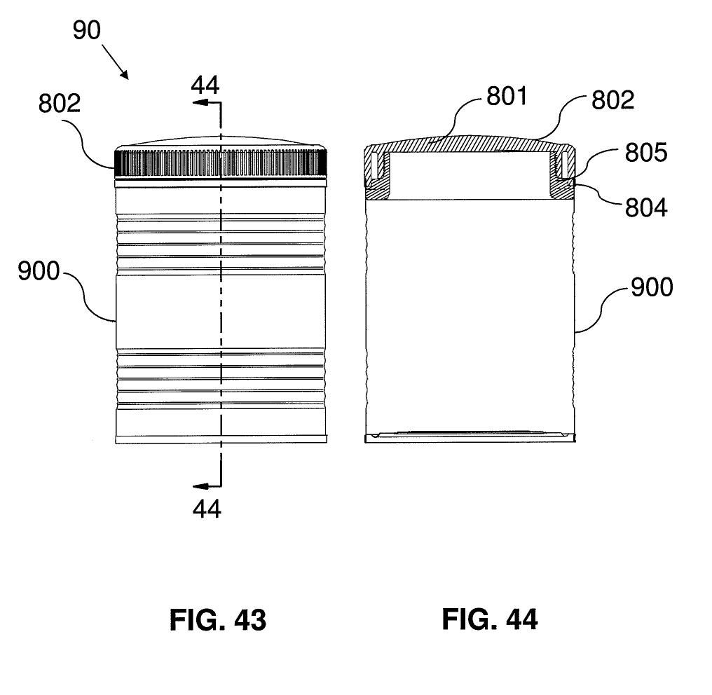

In another embodiment, FIGS. 43-44 illustrate a container 90, that may be used for storing and dispensing food. Container body 900 is attached to closure system 802. Closure system 802 comprises removable closure element 801 which encloses the remaining components of the container's closure system 802. FIG. 44 is a cross-sectional view of container 90, and illustrates container 90 comprising top-mounted, top-inserted dispensing portion 805 and top-mounted, top-inserted rim 804.

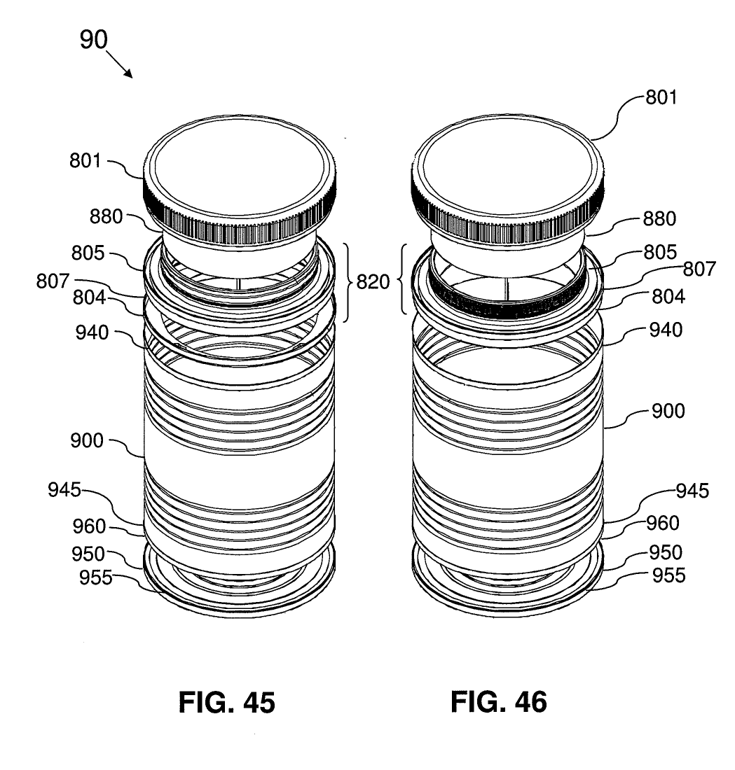

As illustrated in the exploded views of FIGS. 45 and 46, fixed element 820 may comprise one or more components that may or may not be mated or preassembled prior to attachment to container body 900. For example, FIG. 45 illustrates fixed element 820 comprising components of dispensing portion 805 and rim 804 that are not preassembled. In another example, FIG. 46 illustrates fixed element 820 comprises rim 804 molded within dispensing portion 805. In any configuration of fixed element 820, rim 804 may comprise flange 807 to secure fixed element 820 to container body 900. Dispensing portion 805 and rim 804 may be confined to provide a wider opening to easily access the contents.

Container 90 comprises protective cover 880 to further ensure the integrity of the contents of container 90. Protective cover 880 may reside between fixed element 820 and removable closure element 801 and may be made of any suitable material, for example, plastic or aluminum foil. Container 90 also comprises base plate 950 having flange 955. Base plate 950 may be mated to container body 900 at end 945 by mating the two components. In accordance with certain examples, base plate 950 is mated to container body 900 as described above with reference to FIG. 34. Edge 960 of container body 900 is folded outward by flange 955 of base plate 950 such that edge 960 is approximately parallel to container body 900. Flange 955 is curved around edge 960 to secure edge 960 once flange 955 is crimped and flattened against container body 900. This attachment process to form a double seam hermetic seal may be performed using conventional can manufacturing processes.

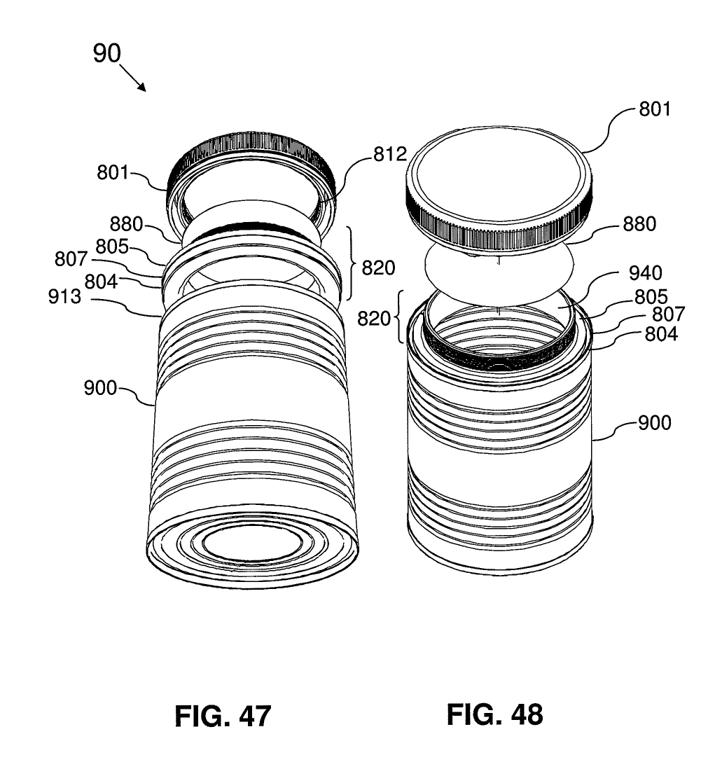

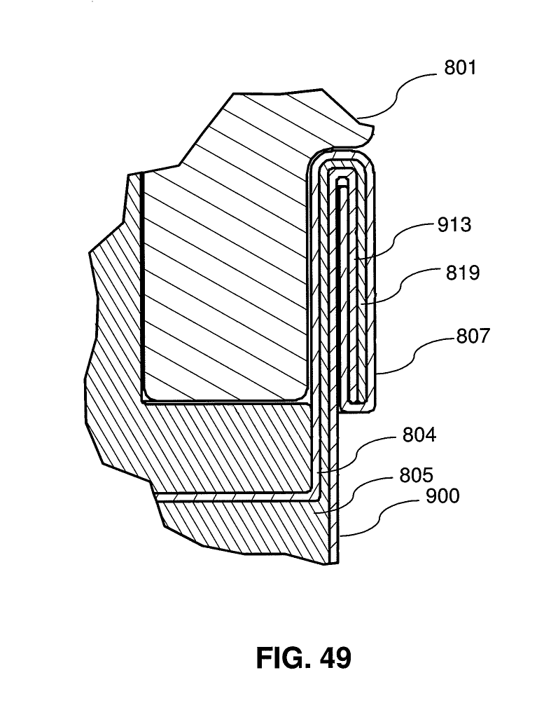

Likewise, fixed element 820 may be mated to container body 900 at end 940 by any suitable means. In accordance with certain embodiments, as illustrated in FIGS. 47 and 48, fixed element 820 comprising dispensing portion 805 and rim 804 is secured to container body 900 at end 940. Flange 807 of rim 804 may be mated with edge 913 of container body 900.

As illustrated in FIG. 49, flange 807 of rim 804 may be curled around edge 913, and crimped and flattened against container body 900 to form a double seam hermetic seal. A portion 819 of dispensing portion 805 may also be incorporated in the double seam seal. This attachment process may be performed using conventional can manufacturing processes.

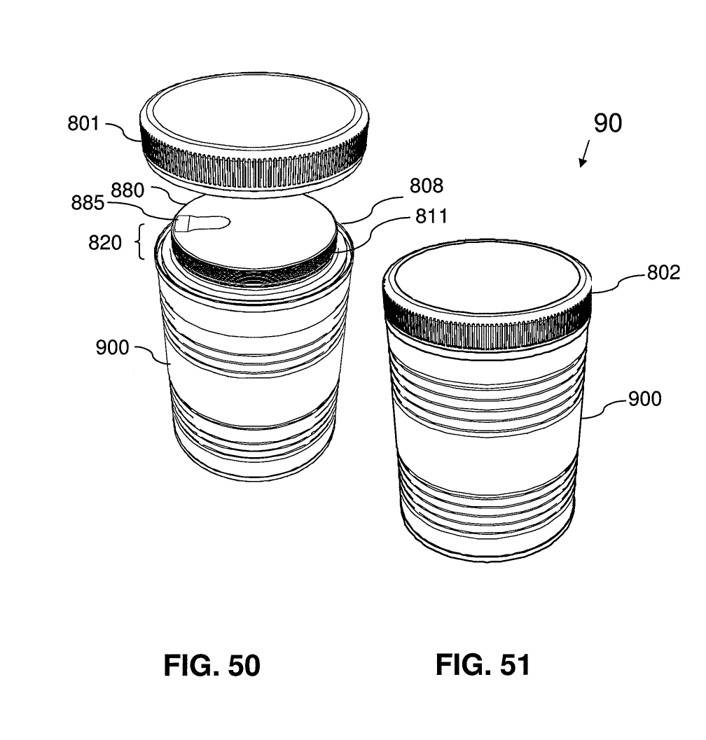

As illustrated in FIGS. 50 and 51, once the contents have been added to container 90, protective cover 880 is mated to fixed element 820, for example, through use of an adhesive. Protective cover 880 may comprise tab 885 to allow ease of opening of protective cover 880. Removable closure element 801 may then be mated to spout 808 of dispensing portion 805 having threaded surface 811 which is compatible with threaded surface 812 (shown in FIG. 47) of removable closure element 801. FIG. 51 illustrates a completely assembled container 90 comprising container body 900 and closure system 802.

Any of the arrangements described above may be used for beverages, foods, other consumable goods, or nonconsumable goods. Additionally, as described above, containers may be made from any material known to those skilled in the art, depending on the use and function of the part or component. For example, container bodies and base plates may be made from aluminum materials used in the conventional manufacturing of can bodies. The removable closure elements, dispensing portions, spouts, locknuts, tabs, and rims may be formed from common molding and extrusion processes to create reproducible tolerances. The removable closure elements may be formed from polypropylene, while the dispensing portions, spouts, locknuts, tabs, and rims may be manufactured from polyethylene terephthalate. Alternatively, the rims may be manufactured from aluminum materials used in the conventional manufacturing of can bodies. The gaskets and o-rings may be made of silicon, rubber, plastic, or the like.

Although the containers and methods of making them have been described above in terms of certain examples and embodiments, various alterations, modifications, substitutions, additions and improvements will be readily apparent to the person of ordinary skill in the art, given the benefit of the disclosure. Such alterations, modifications, substitutions, additions and improvements are intended to be within the scope and spirit of the containers disclosed here. It is also intended that the indefinite articles “a” and “an,” as used above and in the appended claims, mean one or more of the articles which they modify, and that the terms “include,” “including” and “having” are interchangeable with the open ended term “comprising.” Only the transitional phrases “consisting of” and “consisting essentially of,” are closed or semi-closed transitional phrases, respectively, with respect to the claims.

Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for the use of the ordinal term) to distinguish the claim elements.

Those skilled in the art should appreciate that the parameters and configurations described herein are exemplary and that actual parameters and/or configurations will depend on the specific application in which the systems and techniques of the invention are used. Those skilled in the art should also recognize, or be able to ascertain, using no more than routine experimentation, equivalents to the specific examples of the invention. It is therefore to be understood that the examples described herein are presented by way of example only and that, within the scope of the appended claims and equivalents thereto, the invention may be practiced otherwise than as specifically described.

What is claimed is:

1. A container comprising:
a container body; and
a closure system comprising a removable closure element, and a fixed element secured to the container body and comprising
a dispensing portion comprising a spout constructed and arranged to be mated with the removable closure element; and
a rim constructed and arranged to secure the dispensing portion to the container body.

2. The container of claim 1, wherein at least a portion of the rim is disposed within the dispensing portion.

3. The container of claim 1, wherein the removable closure element comprises a first component and a second component.

4. The container of claim 3, wherein the first component is constructed and arranged to be mated with the dispensing portion and the second component.

5. The container of claim 4, wherein the second component is constructed and arranged to be mated with the first component.

6. The container of claim 1, wherein the fixed element further comprises a locknut constructed and arranged to be mated with the dispensing portion.

7. The container of claim 1, wherein the dispensing portion comprises a first threaded surface.

8. The container of claim 7, wherein the locknut has a threaded surface that is compatible with the first threaded surface of the dispensing portion.

9. The container of claim 7, wherein the dispensing portion has a second threaded surface that is compatible with a threaded surface of the removable closure element.

10. The container of claim 1, further comprising a gasket constructed and arranged to conform to a surface of the dispensing portion.

11. The container of claim 10, wherein the gasket is disposed between the rim and the dispensing portion

12. The container of claim 1, wherein a flange of the rim is mated with an edge of the container body to secure the dispensing portion to the container body.

13. The container of claim 12, wherein the flange of the rim and the edge of the container are constructed and arranged to form a seam.

14. The container of claim 1, where the rim comprises an opening having a pre-determined cross-sectional shape.

15. A container comprising:
a container body;
a closure system comprising a removable closure element, and a fixed element secured to the container body and comprising
a dispensing portion comprising a spout constructed and arranged to be mated with the removable closure element, and a sealing portion constructed and arranged to secure the dispensing portion to the container body; and
a base plate constructed and arranged to be attached to the container body opposite the closure system.

16. The container of claim 15, wherein the removable closure element comprises a first component and a second component.

17. The container of claim 16, wherein the first component is constructed and arranged to be mated with the dispensing portion and the second component.

18. The container of claim 17, wherein the second component is constructed and arranged to be mated with the first component.

19. The container of claim 15, wherein the removable closure element has a threaded surface compatible with a first threaded surface of the dispensing portion.

20. The container of claim 15, wherein the sealing portion is constructed and arranged to be mated with the dispensing portion.

21. The container of claim 20, wherein the sealing portion has a threaded surface compatible with a second threaded surface of the dispensing portion.

22. The container of claim 15, wherein the sealing portion comprises a first component disposed between the dispensing portion and a second component.

23. A method of making a container comprising:
providing a container body;
disposing a closure system comprising a removable closure element and a fixed element comprising a dispensing portion and a rim to a first end of the container body having a first edge; and
securing the rim to the first edge of the container body.

24. The method of claim 24, wherein the securing step comprises curling a flange of the rim around the first edge of the container body to form a partial seam.

25. The method of claim 24, wherein the securing step further comprises crimping and flattening the partial seam to form a hermetic seal.

26. A method of making a container comprising:
providing a container body comprising a first opening and a second opening opposite the first opening;
securing a closure system comprising a removable closure element and a fixed element to the first opening; and
attaching a base plate to the second opening of the container body.

27. The method of claim 26, wherein the securing step comprises moving at least a portion of the fixed element through the second opening to secure the fixed element to the first opening.

28. The method of claim 26, wherein the attaching step comprises curling a flange of the base plate around an edge of the second opening of the container body.

29. The method of claim 28, wherein the attaching step further comprises crimping and flattening the partial seam to form a hermetic seal.
